(19) United States
(12) Patent Application Publication
(10) Pub. No.: US 2022/0354122 A1
(43) Pub. Date: Nov. 10, 2022

(54) pH/CO2-RESPONSIVE SMART ANTI-PATHOGEN COATINGS THAT CONTROL, REPEL, AND/OR INACTIVATE VIRUSES AND BACTERIA

(71) Applicant: THE UNIVERSITY OF HONG KONG, Hong Kong (HK)

(72) Inventors: Liqiu Wang, Hong Kong (HK); Ying Chu, Hong Kong (HK)

(21) Appl. No.: 17/738,037

(22) Filed: May 6, 2022

Related U.S. Application Data
(60) Provisional application No. 63/185,390, filed on May 7, 2021.

(51) Int. Cl. A01N 59/16; A01N 25/10; A01N 33/12; A01P 1/00

(52) U.S. Cl. CPC A01N 59/16; A01N 25/10; A01N 33/12; A01P 1/00

(57) ABSTRACT

Disclosed is a coating with reversible wettability, the coating having a hydrophobic state wherein the anti-pathogen coating has a hydrophobic surface that repels at least one of bacteria, fungi, and viruses; and a hydrophilic state wherein the anti-pathogen coating has a hydrophilic surface that inactivates at least one of bacteria, fungi, and viruses, wherein the hydrophobic state switchable to the hydrophilic state by exposure to a first switching stimulus and the hydrophilic state switchable to the hydrophobic state by exposure to a second switching stimulus. This reversible wettability switch between superhydrophobicity and superhydrophilicity can be repeated at least three times, which indicating the process for controlled repellent or inactivation of bacteria, fungi, or viruses can be converted at least three times.

### CROSS-REFERENCE TO RELATED APPLICATIONS

This application claims priority to U.S. Provisional Application Ser. No. 63/185,390 filed on May 7, 2021, the entire contents of which are incorporated herein by reference.

### TECHNICAL FIELD

Disclosed are anti-pathogen coatings and methods of preventing spread of at least one of bacteria, fungi, and viruses, and methods of making an anti-pathogen coating.

### BACKGROUND

The development of liquid-repellent surfaces is an effective approach for reducing the contamination of viruses/bacteria due to its self-cleaning and water-repellent properties. However, there still exists virus remnants due to adhesion, which detrimentally transforms surfaces into fomites.

### SUMMARY

The following presents a simplified summary of the invention in order to provide a basic understanding of some aspects of the invention. This summary is not an extensive overview of the invention. It is intended to neither identify key or critical elements of the invention nor delineate the scope of the invention.

Rather, the sole purpose of this summary is to present some concepts of the invention in a simplified form as a prelude to the more detailed description that is presented hereinafter.

In view of the problems described above, it is of great importance to design novel smart anti-pathogen surfaces to repel and inactivate any virus (particularly SARS-CoV-2) or bacterium attached on the surfaces in a controllable manner.

Disclosed herein is a coating, such as an anti-pathogen coating, with reversible wettability, the coating having a hydrophobic state wherein the coating has a hydrophobic surface that repels a fluid containing at least one of bacteria, fungi, and viruses; and a hydrophilic state wherein the coating has a hydrophilic surface that anchors the fluid and inactivates at least one of bacteria, fungi, and viruses, wherein the hydrophobic state switchable to the hydrophilic state by exposure to a first switching stimulus and the hydrophilic state switchable to the hydrophobic state by exposure to a second switching stimulus.

Also disclosed are methods of preventing spread of at least one of bacteria, fungi, and viruses involving applying an anti-pathogen coating with reversible wettability to a solid surface, the anti-pathogen coating comprising a hydrophobic surface; and exposing the anti-pathogen coating comprising the hydrophobic surface to a switching stimulus to generate the anti-pathogen coating comprising a hydrophilic surface wherein the anti-pathogen coating with the hydrophilic surface inactivates at least one of bacteria, fungi, and viruses.

Also disclosed are methods of making an anti-pathogen coating with reversible wettability, involving polymerizing an alkylsulfanylthiocarbonylsulfanyl-carboxylic acid; and adding at least one of Ag particles, tertiary-amine groups, carboxyl groups, and quaternary ammonium compounds-to the polymerization product.

To the accomplishment of the foregoing and related ends, the invention comprises the features hereinafter fully described and particularly pointed out in the claims. The following description and the annexed drawings set forth in detail certain illustrative aspects and implementations of the invention. These are indicative, however, of but a few of the various ways in which the principles of the invention may be employed. Other objects, advantages and novel features of the invention will become apparent from the following detailed description of the invention when considered in conjunction with the drawings.

### BRIEF SUMMARY OF THE DRAWINGS

FIG. 1 depicts (A) and (B) that are scanning electron microscope images of the surface of pH/CO₂-responsive smart copper plate at a 1 micron level and a 10 micron level, respectively. (C) and (D) are scanning electron microscope images of the surface of bare copper plate at a 1 micron level and a 10 micron level, respectively.

FIG. 2A graphically depicts is the reversible wettability of the pH/CO₂-responsive smart copper plate for water droplets after three cycles.

FIG. 2B graphically depicts is the adhesive force of the pH/CO₂-responsive smart copper plate for a water droplet in air.

FIG. 3 (FIG. 3a and FIG. 3b) depict wettability and contact angle.

FIG. 4 depicts wettability and contact angle theta.

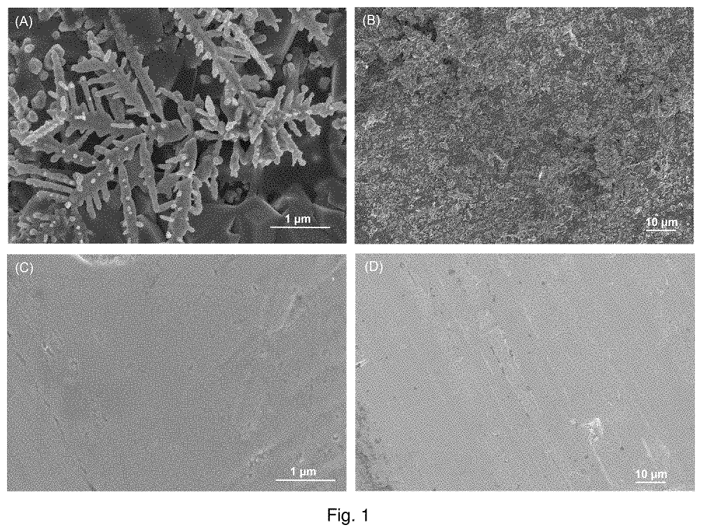

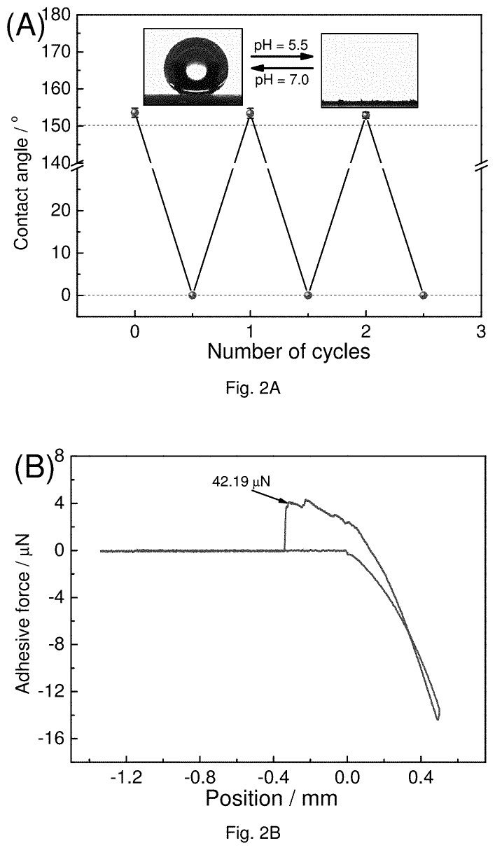

### DETAILED DESCRIPTION

Described herein is the development of pH/CO₂-responsive smart anti-pathogen coatings with tunable wettability that at least one of repel virus/bacterium-laden droplets (or fluids) and inactivate the residual virus/bacterium. The surface wettability is switchable between superhydrophobicity and superhydrophilicity by pH/CO₂ stimuli. The smart anti-pathogen coatings effectively repel the virus/bacterium-laden droplets in the superhydrophobic state. After exposure to a switching stimulus, such as an acidic aqueous solution/sodium bicarbonate solution/water that dissolved CO₂, the surfaces of the anti-pathogen coating successfully change the wettability from superhydrophobicity to superhydrophilicity. In the superhydrophilic state, the surfaces can anchor the virus/bacterium-laden droplets and firmly bind with the virus/bacterium through hydrophobic and electrostatic interactions. As a result of such interactions, virus's disintegration ensues manifesting itself in a leakage of RNA into solution and a loss of infectivity.

The techniques described herein attempt to improve the response rate of the reversible switch between superhydrophobicity and superhydrophilicity of the anti-pathogen coatings. Herein, completing a reversible cycle between superhydrophobicity and superhydrophilicity usually requires at least 20 minutes but less than 2 hours. In another embodiment, completing a reversible cycle between superhydrophobicity and superhydrophilicity usually requires at least 30 minutes but less than 1 hour.

Smart anti-pathogen coatings with reversible wettability are developed to make the surfaces repel and inactivate broad spectrum of bacteria, fungi and viruses, including SARS-CoV-2. The surface wettability is switchable between superhydrophobicity and superhydrophilicity in response to a switching stimulus, such as a pH/CO₂ stimulus. Virus/bacteria-laden droplets (or fluids) are shed away by the surface in the superhydrophobic state while anchoring on the surface in the superhydrophilic state. The superhydrophilic coatings impregnating with antiviral and antimicrobial agents, such as quarternary ammonium compounds, protonated tertiary amines groups, carboxyl groups, and/or silver, are capable of killing the viruses or bacteria in contact with them. The smart coatings can be applied to solid surfaces such as metals, plastics, glass, polymers, paper, textiles, fabrics, gauze, and other fibers.

The switchable wettability behavior of the coatings originates from the reversible protonation/deprotonation of, for example, the tertiary amine groups in CO₂-responsive polymer molecules. The hydrophobic polymer chains maintain in a dehydrated and collapsed form in a neutral aqueous solution. Upon exposure to dCO₂ (or NaHCO₃) solution, the tertiary amine groups in the CO₂-responsive polymer are protonated into positive-charged tertiary amines by carbonic acid produced from the reaction of CO₂ with water, exhibiting a hydrophilic conformation. With the reversible change in the chemical structure of the polymer chains, the surface wettability can be switched repeatedly.

Elements of the smart anti-pathogen coatings include the liquid-repellent surfaces with reversible wettability having much greater efficacy against a broad range of viruses and bacteria, particularly the SARS-CoV-2. For example, the smart anti-pathogen coating can effectively repel the SARS-CoV-2 virus-laden droplets by a rate of 99.98% in the superhydrophobic state. In another embodiment, the smart anti-pathogen coating can effectively repel the SARS-CoV-2 virus-laden droplets by a rate of 99.99% in the superhydrophobic state. Elements of the smart anti-pathogen coatings also include a pH/CO₂-responsive polymer carboxyl-terminated poly(2-(diethylamino)ethyl methacrylate) that is virucidal. The virucidal efficiency of this polymer is greater than 80%. In another embodiment, the virucidal efficiency of this polymer is greater than 85%.

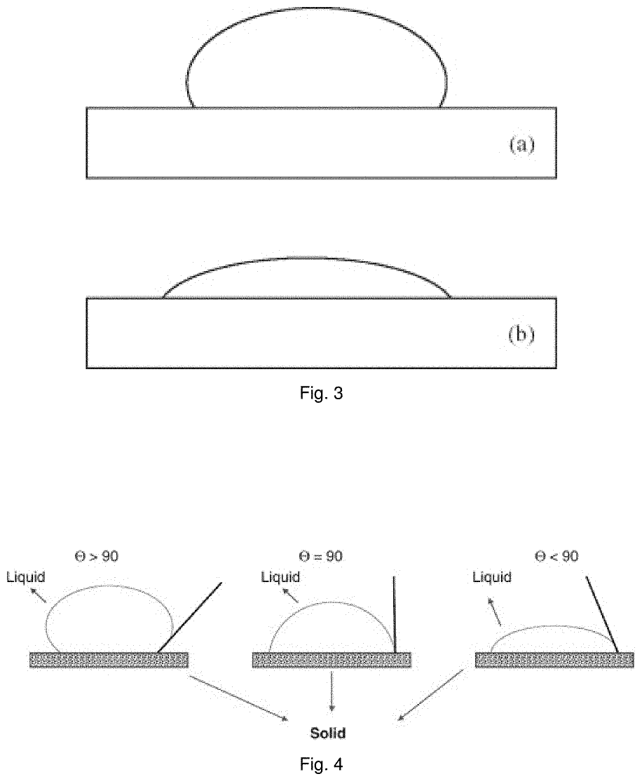

As shown in FIG. 3, a contact angle value is used as a criterion for wettability of solid by liquid. In general, when a contact angle is larger than 90 degrees (see FIG. 3a), it is defined as “non-wetting system” or “hydrophobic” and when a contact angle is smaller than 90 degrees (see FIG. 3b), it is defined as “wetting system” or “hydrophilic”. In another embodiment, a hydrophobic coating has a contact angle value of 100 degrees or more and a hydrophilic coating has a contact angle value of 80 degrees or less. In yet another embodiment, a hydrophobic coating has a contact angle value of 120 degrees or more and a hydrophilic coating has a contact angle value of 60 degrees or less. FIG. 4 provides another perspective for viewing contact angle (theta).

Described herein is the fabrication and use of pH/CO₂-responsive smart anti-pathogen coatings that offer tunable wettability and anti-pathogen properties. The coatings include pH/CO₂-responsive polymer, low-surface-energy material, and a layer of metal Ag. The Ag layer provides the hierarchical roughness of the surface. Such coatings with a low surface energy and contain surfaces with a hierarchical nano/microstructure represent the basis for superhydrophobicity. Through the modification of pH/CO₂ responsive polymer, the wettability behavior of the surface is controlled by changing the external stimuli. For example, the coating is surperhydrophobic in air at pH 7 or more and superhydrophilic in aqueous media at pH 5.5 or less. Moreover, the coatings described herein exhibit tunable anti-pathogen property that is tuned by the wettability of the surfaces. Virus/bacterium-laden aqueous droplets (fluids) are shed away by the surface in the superhydrophobic state while anchoring on the surface in the superhydrophilic state.

Also described herein is the finding that the pH/CO₂-responsive polymer carboxyl-terminated poly(2-(diethylamino)ethyl methacrylate) which includes tertiary-amine and carboxyl groups are virucidal/germicidal. Upon exposure to weak acidic solution (for instance, pH 5.5 or less), the tertiary-amine groups in the pH/CO₂ responsive polymer molecules are protonated into positive-charged tertiary amines. When the Virus/bacterium-laden aqueous droplets (fluids) adhere to the superhydrophilic coating, the viruses/bacteria (especially SARS-CoV-2) can be inactivated by the positive-charged tertiary amines and negative-charged carboxyl groups.

Such pH/CO₂ responsive smart anti-pathogen coatings are built following a two-step approach, which is capable of being applied to a variety of metals, plastics, glass, polymers, paper, textiles, fabrics, gauze, and other fibers substrates of various size, shape, and geometry. The applications of such coatings may be in the form of one or more of anti-microbial, anti-wetting, anti-corrosion, self-cleaning, or de-icing applications.

As a general example, the smart anti-pathogen coatings contain a sufficient amount of pH/CO₂ responsive polymer and anti-viral particle (and/or anti-bacterial, anti-fungal per the desired circumstance, but simply ant-viral for brevity) to possess both the properties of hydrophobic—hydrophilic switching and virucidal/viral replication inhibiting (and/or corresponding anti-bacterial and/or anti-fungal properties). In one embodiment, the smart anti-pathogen coatings contain from 2% to 20% by weight of pH/CO₂ responsive polymer, from 5% to 40% by weight anti-viral particle, the balance being other coating materials and/or additives that facilitate coating formation but do not inhibit the properties of the pH/CO₂ responsive polymer and anti-viral particle. In another embodiment, the smart anti-pathogen coatings contain from 3% to 15% by weight of pH/CO₂ responsive polymer, from 10% to 30% by weight anti-viral particle. In yet another embodiment, the smart anti-pathogen coatings contain from 4% to 12% by weight of pH/CO₂ responsive polymer, from 15% to 25% by weight anti-viral particle.

Preparation of pH/CO₂Responsive Smart Coatings

The pH/CO₂-responsive copolymer carboxyl-terminated poly(2-(diethylamino)ethyl methacrylate) (PDEM-CT) is synthesized by reversible addition-fragmentation transferl (RAFT) polymerization. At first, 2-dodecylsulfanylthiocarbonylsulfanyl-2-methyl propionic acid (DMP) is synthesized. The DMP is prepared as follows. Typically, 8.076 g of 1-dodecanethiol, 19.24 g of acetone and 0.6 g of tricaprylylmethylammonium chloride are agitated at 10° C. in an argon atmosphere. Then 1.6 mL of aqueous NaOH solution (50 wt %), 3.04 g of CS₂ and 4.04 g of acetone are successively added to the mixture dropwise. After stirring for 15 min, 7.13 g of CHCl₃ is poured into the above mixture. Later, 1.6 mL of aqueous NaOH solution (50 wt %) is added dropwise to the resulting mixture. After stirring at room temperature for 8 h, 60 mL of water and 10 mL of concentrated HCl are successively added to the mixture. At last, the acetone is removed by reduced pressure distillation. The obtained solid is washed with 2-propanol and dries at room temperature.

Then, DEAEMA (364.64 mg), DMP (16.4 mg), and AIBN (30 mg) are dissolved into 6 mL of 1, 4-dioxane in a Schlenk flask and the above mixture is carefully degassed by three freeze-vacuum-thaw cycles. The reaction is continued at 70° C. for 18 h under vacuum. After polymerization, the product is diluted with 5 mL of 1, 4-dioxane and purifies by dialyzing in distilled water (pH 4.5) for 72 h. Finally, the solid product is collected and dried by lyophilization. In an exemplary embodiment, a piece of copper plate is immersed into 1.0 mg ml⁻¹ aqueous AgNO₃ solution. This solution is irradiated by ultraviolet (UV, 254 nm, 3W) lamp for 20 min to deposit a layer of Ag nanoparticles on the copper plate. After washing with distilled water and drying in air, the obtained copper plate is incubated into an ethanol solution containing 50 mg mL⁻¹ of pH/CO₂-responsive copolymer and 1 μL mL⁻¹ of 1H, 1H, 2H, 2H-perfluorodecanethiol for 8 h. After that, the sample is washed with ethanol to remove the adsorption chemicals and then dries at 50° C. in vacuum for 5 h.

The resulting copper plate exhibits superhydrophobicity with a water contact larger than 150°. The virus remnants on the surface of superhydrophobic copper plate is determined on the basis of viral genome copy number using quantitative RT-PCR (Real-time Polymerase Chain Reaction). It is found that the superhydrophobic copper plate can effectively repel the SARS-CoV-2 virus-laden droplets by a rate of 99.98%. When the as-prepared copper plate exposes to weak acidic solution (pH 5.5), the surface of the copper plate changes its wettability from superhydrophobicity to superhydrophilicity with a water contact of 0°. The superhydrophilic copper plate is placed into 24-well plates and the droplets of SARS-CoV-2 solution in Dulbecco's Modified Eagle Medium (DMEM) are deposited in the center of the copper plate. After an incubation for 24 h, the result copper plate is removed and SARS-CoV-2 in the plates are aliquoted for plaque assays on VeroE6 cells in 6-well plates for determination of viral infectivity. The plaques on VeroE6 cells are stained and counted at 72 hours post infection. The results show that the virucidal efficiency of the smart anti-pathogen coating is 85.3%.

Unless otherwise indicated in the examples and elsewhere in the specification and claims, all parts and percentages are by weight, all temperatures are in degrees Centigrade, and pressure is at or near atmospheric pressure.

With respect to any figure or numerical range for a given characteristic, a figure or a parameter from one range may be combined with another figure or a parameter from a different range for the same characteristic to generate a numerical range.

Other than in the operating examples, or where otherwise indicated, all numbers, values and/or expressions referring to quantities of ingredients, reaction conditions, etc., used in the specification and claims are to be understood as modified in all instances by the term “about.” While the invention is explained in relation to certain embodiments, it is to be understood that various modifications thereof will become apparent to those skilled in the art upon reading the specification. Therefore, it is to be understood that the invention disclosed herein is intended to cover such modifications as fall within the scope of the appended claims.

What is claimed is:

1. A coating with reversible wettability, comprising:
a hydrophobic state wherein the coating has a hydrophobic surface that repels a fluid comprising at least one of bacteria, fungi, and viruses; and
a hydrophilic state wherein the coating has a hydrophilic surface that anchors the fluid and inactivates at least one of bacteria, fungi, and viruses,
wherein the hydrophobic state switchable to the hydrophilic state by exposure to a first switching stimulus and the hydrophilic state switchable to the hydrophobic state by exposure to a second switching stimulus.

2. The coating according to claim 1, wherein the coating comprises at least one of protonated tertiary amines, carboxyls, quaternary ammonium compounds, and silver particles.

3. The coating according to claim 1, wherein the coating comprises a carboxyl-terminated poly(2-(diethylamino)ethyl methacrylate) with tertiary-amine and carboxyl groups.

4. The coating according to claim 1, wherein the first switching stimulus is an acidic aqueous solution/sodium bicarbonate solution/water that dissolved CO₂.

5. The coating according to claim 1, wherein the at least one of bacteria, fungi, and viruses is SARS-CoV-2 virus.

6. The coating according to claim 1, wherein the hydrophilic state of the coating has a virucidal efficiency of 80% or more.

7. The coating according to claim 1, wherein the hydrophilic state of the coating has a virucidal efficiency of 85% or more.

8. The coating according to claim 1, wherein the hydrophobic state of the coating can effectively repel virus-laden droplets by a rate of 99.98%.

9. The coating according to claim 1, wherein the hydrophobic state of the coating has a hydrophobicity with a water contact larger than 150°.

10. The coating according to claim 1, wherein the hydrophilic state of the coating has a hydrophilicity with a water contact of 0°.

11. The coating according to claim 1, wherein the second switching stimulus is a water purged with N2 and then drying with N2 in the air.

12. The coating according to claim 1, wherein the hydrophobic state is switchable to the hydrophilic state and the hydrophilic state switchable to the hydrophobic state for at least three cycles.

13. The coating according to claim 1, wherein the coating is an anti-pathogen coating.

14. A method of preventing spread of at least one of bacteria, fungi, and viruses, comprising:
applying an anti-pathogen coating with reversible wettability to a solid surface, the anti-pathogen coating comprising a hydrophobic surface; and
exposing the anti-pathogen coating comprising the hydrophobic surface to a switching stimulus to generate the anti-pathogen coating comprising a hydrophilic surface wherein the anti-pathogen coating with the hydrophilic surface inactivates at least one of bacteria, fungi, and viruses.

15. The method according to claim 14, wherein the solid surface is one or more of a metal, a plastic, a glass, a polymer, a paper, a textile, a fabric, and a gauze.

16. The method according to claim 14, wherein the anti-pathogen coating comprises at least one of protonated tertiary amines, carboxyls, quaternary ammonium compounds, and silver particles.

17. The method according to claim 14, wherein the anti-pathogen coating comprises a carboxyl-terminated poly(2-(diethylamino)ethyl methacrylate) with tertiary-amine and carboxyl groups.

18. The method according to claim 14, wherein the switching stimulus is an acidic aqueous solution/sodium bicarbonate solution/water that dissolved CO₂.

19. The method according to claim 14, wherein the at least one of bacteria, fungi, and viruses is SARS-CoV-2 virus.

20. A method of making an anti-pathogen coating with reversible wettability, comprising:
polymerizing an alkylsulfanylthiocarbonylsulfanyl-carboxylic acid; and
adding at least one of Ag particles, tertiary-amine groups, carboxyl groups, and quaternary ammonium compounds to the polymerization product.
